(19) United States
(12) Patent Application Publication
(10) Pub. No.: US 2011/0054989 A1
(43) Pub. Date: Mar. 3, 2011

(54) Methods for Providing Network Marketing and Revenue Sharing to Participants of an Electronic Marketplace System

(75) Inventors: Thomas Burton, Jackson, MI (US); Anthony Hall, Norvell, MI (US); Jason Thomson, Okemos, MI (US)

(73) Assignee: BHT STOCKS & BONDS, INC., Jackson, MI (US)

(21) Appl. No.: 12/548,325

(22) Filed: Aug. 26, 2009

(51) Int. Cl. G06Q 30/00; G06Q 10/00

(52) U.S. Cl. 705/14.16; 705/30; 705/26.41

(57) ABSTRACT

A method of sharing marketplace revenue includes recognizing revenue generated from the sale of an item supplied to the marketplace by a first marketplace participant and apportioning the revenue to at least a second marketplace participant associated with the first marketplace participant. A computer based system for implementing the foregoing method is also described herein. The system may include a marketplace server connected to a telecommunications network and configured to exchange electronic communications over the network with a plurality of participants and a plurality customers. The system may further include a datastore communicatively coupled to the server configured to store listings of goods and services being offered on the marketplace, the marketplace participant associated with each of the goods and services, transaction details of the sale of items from the listing of goods and services, and a recruitment network identifying recruitment associations between the plurality of participants.

### BACKGROUND

A marketplace provides a forum for buyers and sellers to meet, showcase goods and services, and trade money or other valuable compensation for selected items. Over the last two decades, many marketplaces have been developed to utilize telecommunication networks, such as the Internet to broaden their reach and presence. Accordingly, buyers and sellers typically meet virtually at an electronic marketplace, commonly implemented as an E-commerce website. While some sites are dedicated to a single seller of goods or services, other sites allow for multiple sellers of goods to list their goods and compete for customers. The fantastic proliferation of E-commerce websites, or marketplaces, has resulted in challenges related to marketing the marketplace itself as well as marketing challenges for particular sellers of goods within the marketplace. Moreover, there is tremendous competition for customer given the vast number of E-commerce sites. Similarly, producers of goods and services must choose between the various marketplaces when deciding which marketplace place to use for listing their goods and services.

### SUMMARY

A method of sharing marketplace revenue includes recognizing revenue generated from the sale of an item supplied to the marketplace by a first marketplace participant and apportioning the revenue to at least a second marketplace participant associated with the first marketplace participant. A computer based system for implementing the foregoing method is also described herein. The system may include a marketplace server connected to a telecommunications network and configured to exchange electronic communications over the network with a plurality of participants and a plurality customers. The system may further include a datastore communicatively coupled to the server configured to store listings of goods and services being offered on the marketplace, the marketplace participant associated with each of the goods and services, transaction details of the sale of items from the listing of goods and services, and a recruitment network identifying recruitment associations between the plurality of participants.

### BRIEF DESCRIPTION OF THE DRAWINGS

The features and advantages of the various exemplary approaches of this disclosure, and the manner of attaining them, will become more apparent and better understood by reference to the accompanying drawings, wherein:

FIG. 1 illustrates an exemplary system for an electronic marketplace;

FIG. 2 is a graph illustrating a recruitment network of marketplace participants;

FIG. 3 is a representation of revenue from an item being shared with marketplace participants according to a revenue sharing scheme;

FIG. 4 illustrates a flowchart depicting exemplary steps and decisions relating to the recruitment of a new marketplace participant; and

FIG. 5 illustrates a flowchart depicting exemplary steps and decisions relating to sharing marketplace revenue with marketplace participants.

### DETAILED DESCRIPTION

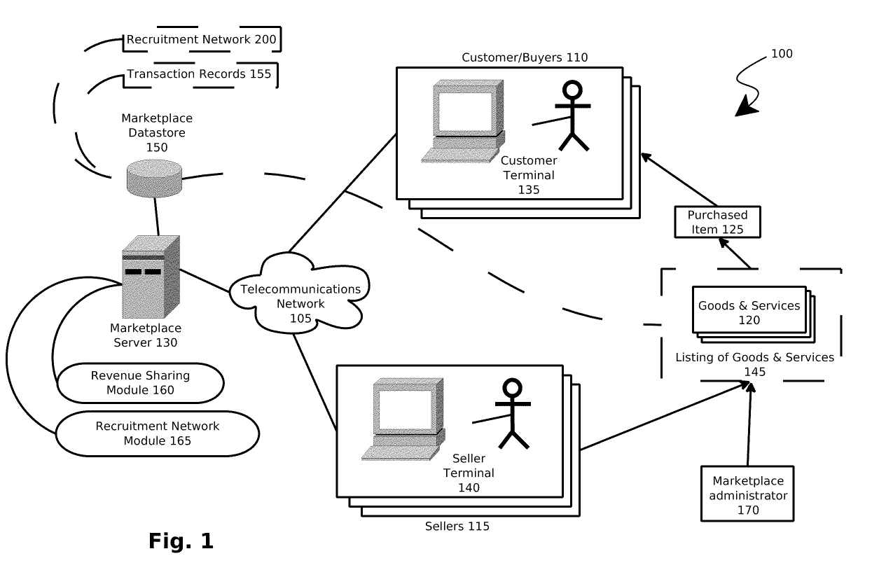

Turning now to FIG. 1a an exemplary electronic marketplace or E-commerce system 100 use a telecommunication system 105, such as the Internet, to connect buyers/customers 110 with sellers 115. In general, sellers 115 produce or supply goods and services 120 and buyers 110 purchase items 125 from among the supplied goods and services. The marketplace 100 typically maintains a marketplace server 130 to facilitate such a transaction. Specifically, the marketplace server 130 receives and sends electronic communications over the telecommunications network 105 to buyers 110 and sellers 115 operating on respective buyer's and sellers terminals 135, 140. Moreover, sellers 115, using a seller's terminal 140, transmits the goods and services 120 that are to be offered, or a representation thereof, to the marketplace server 130. The marketplace sever 130 aggregates the goods and services 120 with those from other sellers 115 and stores a listing of the goods and services 145 in a marketplace datastore 150. Further, and in response to an inquiry from a buyer 110 operating a buyer's terminal 135, the marketplace server 130 presents the listing of goods and services 140 via the telecommunications network 105 to the buyer 110. Upon the purchase of an item 125, the marketplace server 130 will save transaction records 155 related to the transaction, as well as other transactions, in the datastore 150.

As described above, the marketplace 100 acts as an intermediary between buyers 110 and sellers 115. However, in another exemplary approach, a marketplace administrator 170 may play an active role in producing and providing goods and services 125 to the marketplace 100. For example, the marketplace administrator 170 may have the resources, tools, equipment, etc., needed to produce goods, such as electronic multimedia content. Moreover, some sellers 115 may collaborate with the marketplace administrator 170 to produce content. For example, some sellers may have skills such as acting, or the like, or may be able to provide professional services or advice via multimedia content, but might lack the necessary expertise, equipment, resources, etc., that are necessary to produce the multimedia content. Accordingly, the seller 115 may contribute their expertise or persona to goods, e.g., multimedia content, produced and supplied by the marketplace administrator 170. However, participation by the marketplace administrator 170 does not exclude other sellers 115 from producing and supplying content on their own.

It is to be understood throughout this disclosure, that the goods and services 120 may be physical goods, electronic goods or media, or personal or professional services to be provided by the seller 115. Moreover, rather than actually submitting the goods and services 120 to the marketplace 100, the seller 115 may simply provide a description or reference to the goods and services. However, in the case of electronic goods, such as multimedia content, the seller 115 may provide the content to the marketplace server 130, such that it may be distributed to buyers 110 by the marketplace server rather than by the seller. Similarly, physical goods, as well as services, may be distributed directly from the seller 115 to the buyer 110 upon the settling of the purchase by the marketplace server 130.

As will be discussed in considerable detail below, the marketplace server 130 includes a revenue sharing module 160, which includes instructions regarding how the marketplace server 130 should distribute or share the revenue generated from the sale of the item 125. For example, the revenue sharing module 160 may direct the marketplace server 130 to share the revenue with not only the seller 115 of the purchased item 125, but also with other marketplace participants. Moreover, the marketplace server 130 may also include a recruitment network module 165, which includes instructions for developing a recruitment network 200 for the marketplace participants. In consultation with the recruitment network 200, the revenue sharing module 160 may direct the marketplace server 130 to share revenue generated from the sale of the purchased item 125 with one or more marketplace participants that directly or indirectly recruited the seller 115 to the marketplace 100.

The marketplace server 130, customer terminal 135, and seller terminal 140 are interconnected via the telecommunications network 105, which is typically provided by one or more network service providers. The telecommunications network 105 may include both a packet network and a traditional public switch telecommunication network (not shown). Interconnections between packet network, PSTN, and network devices (not shown) may be provided by circuits such as local area networks, digital subscriber lines (DSL), T1 circuits, optical fibers, etc. The telecommunications network 105 may be a local-area network (LAN) or a wide-area network (WAN), and may further be a packet switched communication network such as an Internet Protocol (IP) network. The telecommunications network 105 generally interconnects various computing devices and the like, such as the marketplace server 130, customer terminal 135, and seller terminal 140. Interconnections to telecommunications network 105 may be made by various media including wires, radio frequency transmissions, optical cables, etc. Other devices connecting to telecommunications network 105, e.g. switches, routers, etc., are omitted for simplicity of illustration in FIG. 1.

Marketplace server 130 may be a server based computer system, such as a web application server, configured to provide implement the marketplace system 100. However, any computing device having a computer readable medium including instructions for communicating with the telecommunications network 104 and marketplace datastore 150 may act as marketplace server 130. Marketplace server 130 may be a networked computer system configured with server software for accepting connections via telecommunications network 105. Marketplace server 130 may provide a graphical user interface, such as a web-based interface, for use by buyers 110 and sellers 115. Additionally, marketplace server 130 may provide a remote interface such that buyers 110 and sellers 115 may interact with the server remotely via the telecommunications network 105.

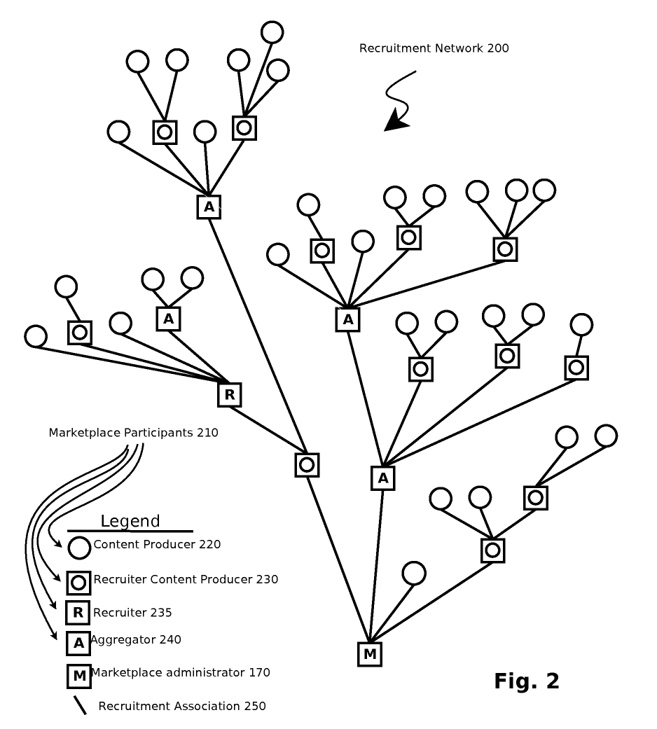

Marketplace datastore 150 may be a relational database management system (RDBMS). Many such systems, including SQL Server, Oracle, and MySQL, among others, are generally available. Marketplace datastore is configured to record listings of goods and services 145 as well as transaction records 155 for recording the details of the sales of items 125. Additionally, marketplace datastore 150 includes seller records that define a recruitment network 200. The recruitment network 200, which will be described in more detail below with respect to FIG. 2, records associations between the sellers, such as which sellers recruited other sellers to the marketplace 100. Marketplace datastore 150 generally stores data in row and column table format, and may include multiple tables. A row, or record, includes one or more columns, or fields, holding data values for specifically defined fields. Rows may be uniquely identified by the values of one or more columns. Indexes of one or more columns can be included to aide in searching for particular rows of the table.

The revenue sharing module 160 may provide computer instructions for sharing and distributing revenue from the sale of an item 125 to the seller 115 and other marketplace participants. Moreover, the instructions may present user interfaces allowing buyers 110 and sellers 115 to interact with the marketplace server 115. For example, interfaces may be provided to allow sellers to describe the goods and services being offered 120, to allow customers to view listings of the goods and services 145, and to complete the transaction details related to the sale of an item 125. Similarly, the revenue sharing module 160 includes instructions for creating database records such as the listing of goods and services 145 and the transaction records 155. While, the instructions of the revenue sharing module 160 may be executed by a user via controls or other interface elements, other instructions may be executed automatically based on a triggering event, or periodically on a set schedule.

The recruitment network module 165 may provide computer instructions for building and maintaining a recruitment network 200. Moreover, the instructions may present user interfaces allowing sellers 115 to interact with the marketplace server 115. For example, interfaces may be provided to allow sellers 115 to apply to the marketplace 100. Moreover, the recruitment network module 165 may analyze the application of a seller 115 to determine if an existing seller should be identified as the recruiter of the new seller. Similarly, the recruitment network module 165 includes instructions from creating database records such as the records of the recruitment network 200. While, the instructions of recruitment network module 165 may be executed by a user via controls or other interface elements, other instructions may be executed automatically based on a triggering event, or periodically on a set schedule.

Customer and seller terminals 135, 140 may be any general purpose computing device, such as a PC or specialized device, connected to the telecommunications network 105. The terminals 135, 140 may have software, such as an operating system with a network protocol stack, for connecting to the marketplace server 130 over the telecommunications network 105. The terminals 135,140 may have additional software for accessing the user interface provided by the marketplace server 130. For example, the terminals 135, 140 may have web browsing software to access a web based user interface of the marketplace server 130.

Computing devices such as the marketplace server 130 and terminals 135, 140, etc., may employ any of a number of computer operating systems, including, but by no means limited to, known versions and/or varieties of the Microsoft Windows, the Unix operating system (e.g., the Solaris operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, a notebook, a laptop, a handheld computer, a cell phone, or some other computing device capable of communicating and interacting with the marketplace server 130.

Computing devices such as the marketplace server 130 and terminals 135, 140, etc., may each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, and volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The marketplace datastore 150 may include a query processor that employs Structured Query Language (SQL) in addition to a language for creating, storing, editing, and executing stored procedures, such as the Procedural Language/Structured Query Language (PL/SQL) utilized by Oracle, as mentioned above. The marketplace datastore 150 may be a type of database other than an RD BMS such as a hierarchical database, a set of files, an application database in a proprietary format, etc. The marketplace datastore 150 generally includes a computing device employing a computer operating system such as one of those mentioned above, and is accessed via a network in any one or more of a variety of manners, as is well known. Exemplary systems are possible in which at least a portion of the marketplace datastore 150 is provided by a database system used for purposes unrelated to the marketplace 100.

As noted above, the marketplace 100 competes with other marketplaces (not shown) to develop networks of customers 110 and sellers 115. So called network-effects play an important factor in attracting both customers 110 and sellers 115. With more sellers 115 offering a diverse set of goods and services, the marketplace 100 will be able to attract more customers 110. Similarly, with more customers 110, the marketplace 100 will be able to attract more sellers 115, higher quality sellers, or perhaps sellers that are willing to pay higher fees to the marketplace. Accordingly, the value of marketplace 100 increases exponentially with respect to both the number of sellers 115 and the number of customers 110. Once a network of buyers 110 and sellers 115 is established, there are great challenges to new entrants that wish to create a new marketplace. Both sellers 115 and customers 110 have little incentive to branch out to a new marketplace unless it has an established network of customers and sellers.

In a market for certain types of goods and services 120, the sellers 115 might only produce or supply goods and services for a limited amount of time. For example, if the seller 115 is offering personal services for sale, the seller might only be qualified to produce the goods and services for a limited amount of time. As another example, buyers 110 may continuously demand new goods and services 120 offerings from a seller 115. However, if the seller 115 is not in a position to continuously update the goods and services 120 that are offered, buyers may move to other sellers. As such, the buyers 110 may enforce an artificial lifespan to the seller's 115 ability to sell items 125 on the marketplace 110.

When sellers 115 have a limited amount of time, for any reason, in which they can successfully sell items 125 to buyers 110, the challenges to the marketplace 110 in maintaining a valuable network of sellers are compounded. For example, for every new seller 115, buyers may be losing interest in an existing seller, which effectively reduces the size of the network. Accordingly, in order to grow the size of the seller network, the marketplace must be able to add new sellers faster than buyers lose interest in the existing sellers.

The marketplace 100 includes a revenue sharing module 160 configured to share revenue generated from the sale of an item 125 with not only the seller 115 of the item, but also with other marketplace participants. By sharing revenue from the sale of an item 125 with sellers 115 that didn't actually produce the item, sellers have an incentive to conduct marketing for the marketplace. Moreover, if the revenue sharing is based on associations with other sellers 115, a particular seller has an incentive to become associated with other sellers. For example, sellers 115 may be given an incentive to recruit new sellers to the marketplace 100.

In one exemplary approach, the revenue sharing module 160 consults a recruitment network 200 to determine how revenue should be shared. With reference to FIG. 2, the recruitment network 200 identifies each of the sellers as marketplace participants 210 based on their respective roles within the network, and further identifies associations between the marketplace participants. It is to be understood, that FIG. 2 presents a graphic illustration of the recruitment network, but that marketplace datastore typically stores the network as database records, e.g., tables and rows.

In this exemplary approach, each marketplace participant 210 may include an association with one other participant. Moreover, the association between the participants may be a recruitment association 250 that identifies which marketplace participant recruited a particular participant to the network 200. Accordingly, the recruitment network 200 may be represented as a graph, or inverted tree as shown in FIG. 2. The marketplace may be considered to be the root of the tree. For example, any participant 210 that has joined the network 200 independently without being recruited by another participant could have the marketplace 100 itself specified as the recruiter. Setting the marketplace 100 as the root of the tree is not technically required, as the revenue sharing module 160 could programmatically determine how to handle a seller's database record that lacks an identified recruiter.

Marketplace participants 210 may be classified into at least four different categories. For example, a seller that merely produces and sells goods and services 120, may be referred to as a content producer 220. Moreover, a seller 115 that has not recruited any other participants 210 to the recruitment network 200 is considered solely a content producer 220. The content producers 220 represent the leaf nodes of the recruitment network 200 due to the fact that no nodes are linked or associated thereto at a higher level. Sellers 115 that have recruited other participants 210, are identified as recruiter content producers 230. From a database standpoint, there may be nothing to distinguish between a seller record of a content producer 220 and the seller record of a recruiter content producer 230.

In one exemplary approach, the recruitment network 200 may be limited to only content producers 220 and recruiter content producers 230. However, in another exemplary approach, the recruitment network 200 may also include aggregators 240. For example, an aggregator 240 may be an entity that doesn't actually produce or offer any goods and services 120 for sale, but merely works with the marketplace 100 to attract and recruit new sellers 115. In one exemplary approach, an aggregator 240 may be a real world entity such as a club, organization, guild, union, etc. in which all recruited participants 210 belong. Moreover, the participants 210 recruited by the aggregator 240 may be contractually bound thereby to identify the aggregator as their recruiter. Even though aggregators 240 do not offer goods and services on the marketplace 100, they may be entitled to receive a share of the revenue sold by the participants 210 that the aggregator recruited to the network 200. Accordingly, aggregators 240 have an incentive to increase the size of the network 200 despite the fact that they are not actually selling goods and services 120 on the marketplace 100. Like the marketplace administrator, the aggregators 240 may participate or facilitate the production of content by the participants 210 that they recruit. Similarly to aggregators, recruiters 235 may be individuals or entities that do not actually produce content or supply goods and services 125 to the marketplace 100. The sole activity of a recruiter 235 may be to recruit new sellers 115 to become marketplace participants 210. However, unlike aggregators 240, recruiters 235 typically do not have any organizationally or contractual relationships with the sellers that they recruit and typically do not assist in the production of content or goods and services 125.

Sharing revenue with marketplace participants also addresses the issue of sellers 115 that have a limited amount of time to sell goods and services on the marketplace. For example, even if buyers 110 lose interest the goods being offered by the seller 115, the seller still has a motivation to stay involved with the marketplace 100 by recruiting new sellers/content producers 220. Moreover, if the seller 115 can receive revenue from the sale of items produced by a content producer 220 that seller recruited, they will have an incentive to recruit as many new sellers as possible. Further, a seller will have an increased incentive to join the marketplace in the first place knowing that even after they are no longer able to sell goods and services they will be able to earn revenue from the sale of items produced by others.

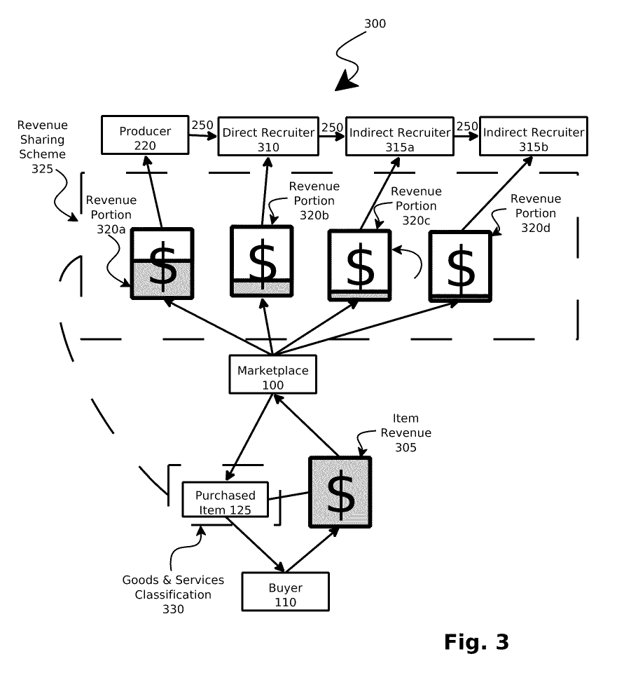

FIG. 3 illustrates a representation 300 of how the marketplace shares revenue 305 from the sale of an item 125 with marketplace participants 210. In one exemplary approach, the marketplace 100 divides revenue 305 from the sale of an item 125 between the producer 200, a direct recruiter 310 of the producer, and indirect recruiters 315a-of the producer. It should be appreciated that this is merely an example and that revenue may be shared with additional recruiters, such as the recruiter of the indirect recruiters 315a-b. Moreover, the marketplace may consult with the recruitment network 200 to determine the recruitment associations 250 of the producer. Typically, the direct recruiter 310 recruited the producer 220 to the marketplace 100, the indirect recruiter 315a recruited the direct recruiter to the marketplace, and the indirect recruiter 315b recruited the indirect recruiter 315a to the marketplace. Accordingly, the indirect recruiter 315 may be a direct recruiter of the direct recruiter 310 of the producer 220. Once identified, the marketplace 100 shares revenue portions 320a-b with the producer and at least one other marketplace participant 210, e.g., the direct recruiter 310, indirect recruiters 315a-b.

While the particular fractional portions 320a-d of the item revenue 305 may be varied based on the conditions and needs of the marketplace 100, the portions will need to be set to properly incentivize the marketplace participants 210. If the producers portion 320a is too low, the seller/producer 220 will have little interest in joining the marketplace 100. Similarly, if the recruiter portions 320b-d are too low, there will be little incentive for existing producers 220 to recruit new sellers 115 to become producers 220. Accordingly, the recruiter portions 320b-d need to be set high enough to encourage and reward recruitment, but not so high as to eliminate a new seller's interest in joining the marketplace 100. Merely as an example, the revenue portion 320b received by the direct recruiter 310 could be 7%, while the revenue portion 320c received by the indirect recruiters 315a-could respectively be 5% and 3%. It is to be understood that the producer/seller 220 receives the same amount of revenue regardless of whether the seller is associated with a direct recruiter 310. Accordingly, there is no benefit to not listing a recruiter because the seller/producer 220 always receives the same compensation. Moreover, from the seller's/producer's perspective, it makes no difference where the seller/producer falls within the recruitment network 200.

The particular fractional amounts of the revenue portions 320a-d may be set in a revenue sharing scheme 325. Moreover, the revenue sharing scheme 325 may establish which marketplace participants receive a share of the revenue 305 in addition to the portion 320a-d thereof. While there may be just a single revenue sharing scheme 325 for all goods and services and producers 220, other approaches may include multiple or variable revenue sharing schemes based on any number of factors, e.g., the identity of the producer 220, the type of item 125, etc. Moreover, goods and services 120 may be logically grouped into a goods and services classification 330. In such an approach, the revenue sharing scheme 325 may be specific to the classification 330 to which the purchased item 125 belongs.

Throughout this disclosure, revenue sharing has been discussed from the perspective of the sale of an item 125. However, it is to be understood that the revenue shared with marketplace participants may be based on the aggregate sales of a number of items. The marketplace 100 may periodically (e.g., monthly) calculate all the total revenue generated by a producer and determine the revenue portions 320b-d based on this total. In yet another exemplary approach, the portions 320a-d may not be directly taken from the item revenue 305 and may be paid by the marketplace from other funding sources, e.g., from a marketing budget. Moreover, the sum of revenue portions 320a-d does not necessarily need to equal the item revenue 305 and may in fact exceed the item revenue.

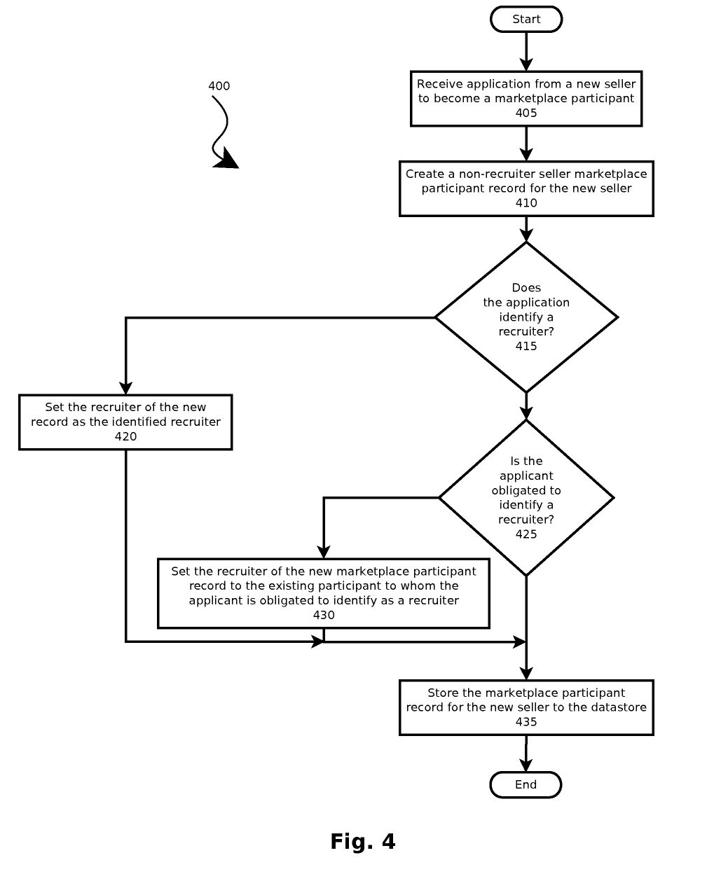

FIG. 4 illustrates a flow chart of an exemplary process 400 for building a recruitment network 200. The marketplace server 130 may include a computer-readable medium having stored instructions for carrying out certain operations described herein, including some or all of the operations described with respect to process 400. For example, some or all of such instructions may be included in the recruitment network module 165. Process 400 is described as an interactive user process. However, it is to be understood that automated or other types of batch processing techniques may implement the following steps.

Process 400 begins in step 405 in which the marketplace 100 receives an application from an applicant desiring to become a new seller/producer 220. For example, the marketplace server 130 may provide a user interface, such as a web interface, for receiving an application from the applicant. The application may request information about the applicant and may further request that the applicant list an existing marketplace participant 210 as the recruiter 310 of the applicant by supplying the name, or other identifier, thereof.

Next, in step 410, a new content producer 220 record is created in the recruitment network 200 of the marketplace datastore 150. The new record is populated with data taken from the application.

Next, in step 415, it is determined whether the applicant identified an existing marketplace participant 210 as a recruiter. For example, the application may have a question that asks the applicant to provide the name, or other identifier of an existing participant 210. Each database record for participants 210 typically includes a unique identifier. In one exemplary approach, the applicant may provide this identifier directly on the application. However, in another exemplary approach, the identifier of the listed recruiter may need to be found in the datastore by searching for the provided identifying information, e.g., the recruiter's name.

If the applicant listed a recruiter, the process proceeds to step 420 in which, the new participant record for the applicant is updated with the identifier of the listed recruiter. By updating the record with the identifier of the recruiter, the datastore 150 establishes a linked recruitment association 250 between the new producer 220 and the recruiter 230 (i.e., direct recruiter 310) thereof.

However, if it is determined in step 415 that the applicant did not list a recruiter, the process proceeds to step 425. In step 425, it is determined whether the applicant is obligated to list a recruiter. For example, the applicant may be a member of a club, guild, union or similar type of organization that contractually obligates the applicant to list a recruiter. The recruiter, such as an aggregator 240, may develop a relationship with the marketplace 100 to enforce these contractual obligations. In one exemplary approach, the marketplace 100 may receive names or other identifying information from a recruiter (e.g., aggregator 240) of any sellers 115 that are contractually obligated to list the aggregator as the recruiter. Accordingly, in step 415, the marketplace may search records, e.g., held within the datastore 150, for an indication that the applicant is obligated to list a recruiter. These records may further provide the identifier of the recruiter to whom the applicant is obligated to list.

If it is determined that the new applicant is obligated to list a recruiter in step 425, the identifier of the recruiter to whom the new applicant is obligated to list as a recruiter may be associated with the participant record of the new applicant. Accordingly, the marketplace 100 may enforce contractual obligations between the producer 220 and the recruiter 230/aggregator 240.

Following each of steps 420, 425, and 430, the newly created producer record for the new applicant is saved to the datastore 150. Moreover, if in step 425 it is determined that the new applicant is not obligated to list a recruiter, the new record will be stored without any identifier for a recruiter. In effect, the new record will be positioned at the lowest level of the recruitment network, immediately above the marketplace 100 itself.

After saving the new record, process 400 ends.

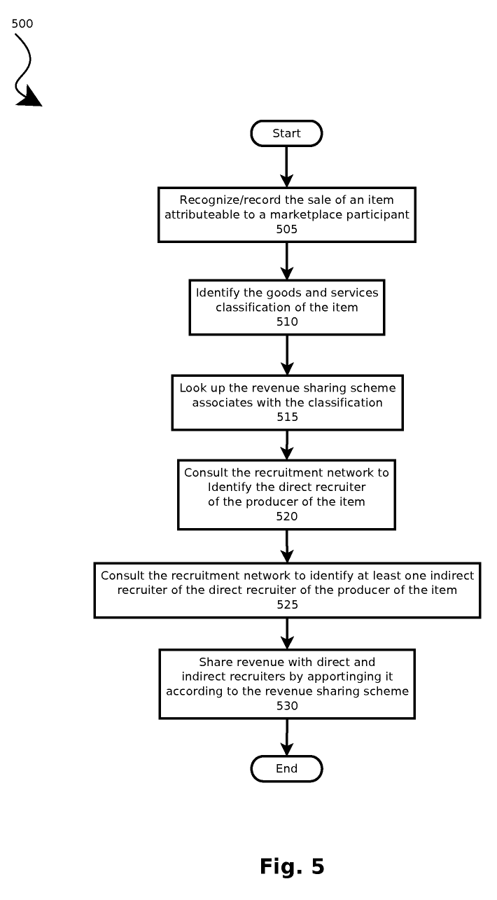

FIG. 5 illustrates a flow chart of an exemplary process 500 for sharing revenue from the sale of an item 125 with marketplace participants 205. The marketplace server 130 may include a computer-readable medium having stored instructions for carrying out certain operations described herein, including some or all of the operations described with respect to process 500. For example, some or all of such instructions may be included in the revenue sharing module 160. Process 500 is described as an interactive user process. However, it is to be understood that automated or other types of batch processing techniques may implement the following steps.

Process 500 begins in step 505 when revenue 305 from the sale of an item 125 is recognized or recorded. For example, the revenue 305 may be recognized at the time of the sale, or some time later such as after the marketplace receives the revenue from the buyer 110 or an intermediary financial institution. Moreover, the marketplace server 130 may be configured to periodically (e.g., daily, weekly, monthly, etc.) reconcile recent transactions such that revenue is not actually recognized until the reconciliation occurs. Regardless, revenue 305 will be attributed to the producer 220 of the purchased item 125 for which the revenue was received.

Next, in step 510, the goods and services classification 330 associated with the item 125may be determined. For example, the datastore 150 may include item records for each of the goods and services 120 listed therein. These item records may include an identifier or reference to a particular goods and services classification 330. If necessary, the classification may be looked up from other classification records in the datastore 150.

Next, in step 515, the revenue sharing scheme associated with the classification 330 may be determined. For example, the datastore 150 may include a table or records holding various revenue sharing schemes 325, each uniquely identified. Each classification 330 may include a reference or identifier of the revenue sharing scheme 325.

Next, in step 520, the direct recruiter 310 of the producer 220 of the item 125 may be determined. For example, the item 125 record typically will be associated or linked to the producer 220 record in the recruitment network 200. As explained above, each producer record 220 may include an identifier, link, association, etc. to the direct recruiter 310 thereof.

Next, in step 525, the indirect recruiters 315a-of the direct recruiter 310 may be determined. As in step 520, the recruitment network 200 records may be searched based on the identifier of the recruiter in the record of the direct recruiter 310. This step may be omitted or repeated any number of times based on the number of marketplace participants 210 that will be sharing the revenue 305 of the item 125. Moreover, the number of times, if any, to conduct step 525 may be based on the revenue sharing scheme 325. For example, the revenue sharing scheme 325 may specify that the revenue 305 should be shared with the direct recruiter 310, as well as with the indirect recruiter 315a and indirect recruiter 315b.

Next, in step 530, the revenue 305 is shared with the marketplace participants 210 according to the revenue sharing scheme 325. For example, the revenue sharing scheme 325 may direct the marketplace 100 to apportion the revenue 305 to the direct recruiter 310, the indirect recruiter 315a, and the indirect recruiter 315b according to specific portion or percentage amounts. In step 530, money or funds are not necessarily transferred or provided to the participants 210. For example, step 530 may simply adjust account balances of each of the participants with new amounts corresponding to the shared revenue. The proceeds of the participant accounts may be distributed, e.g., by check, electronic transfer, etc., to the participants at a later time.

After distributing the revenue, process 500 ends.

Accordingly, the marketplace system 100 provides a virtual forum for buyers 110 and sellers 115 (acting as marketplace participants 210) to meet and exchange goods and services 120. For example, the buyer 110 may purchase an item 125 in exchange for compensation that is recognized as revenue 305 by the marketplace 100. The marketplace 100 maintains a recruitment network 200 identifying recruitment associations 250 between the marketplace participants 210. Under consultation of the recruitment network 200, the revenue 305 may be shared with the direct recruiter 310 of the producer 220 of the item 125, as well as with indirect recruiters 315a-thereof. The revenue may be apportioned according to amounts or percentages specified in a revenue sharing scheme 325, which may be specific to the goods and services classification of the item 125.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain systems, and should in no way be construed so as to limit the claimed invention.

Accordingly, it is to be understood that the above description is intended to be illustrative and not restrictive. Many systems and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future systems. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites explicitly to the contrary.

1. A method of sharing marketplace revenue, comprising:
recognizing revenue generated from the sale of an item supplied to the marketplace by a first marketplace participant; and
apportioning the revenue to at least a second marketplace participant associated with the first marketplace participant.

2. The method according to claim 1, wherein each marketplace participant is one of a content producer, a recruiter content producer, and a content producer aggregator.

3. The method according to claim 1, further comprising:
basing the apportioning on a revenue sharing scheme.

4. The method according to claim 3, further comprising:
determining a classification of the item, and
utilizing the revenue sharing scheme specific to the classification.

5. The method according to claim 1, further comprising:
consulting a recruitment network;
identifying the at least a second marketplace participant as a recruiter of the first marketplace participant based on the recruitment network.

6. The method according to claim 1, further comprising:
identifying a direct recruiter and an indirect recruiter as the at least a second marketplace participant, and wherein the direct recruiter recruited the first marketplace participant to the marketplace, and an indirect recruiter recruited the direct recruiter to the marketplace.

7. The method according to claim 1, further comprising:
admitting a seller of goods or services to the marketplace; and
identifying an existing marketplace participant as a recruiter of the seller of goods.

8. A method of sharing marketplace revenue, comprising:
building a recruitment network of a plurality of marketplace participants, including:
receiving an application from a seller to join the plurality of marketplace participants;
identifying an existing marketplace participant as a direct recruiter of the seller;
admitting the seller as a new participant to the plurality of marketplace participants; and
linking the new participant to at least one existing participant of the plurality of marketplace participants;
presenting a listing of goods and services from the participants to customers;
recording a sale of an item in the listing;
attributing the sale to a first marketplace participant associated with the item;
sharing the revenue from the sale with at least the first marketplace participant and at least the direct recruiter thereof.

9. The method according to claim 8, further comprising: sharing the revenue with an indirect recruiter of the first marketplace participant, wherein the indirect recruiter recruited the direct recruiter to the marketplace.

10. The method according to claim 8, further comprising: basing the sharing on a revenue sharing scheme.

11. The method according to claim 10, further comprising:
determining a classification of the item, and
utilizing the revenue sharing scheme specific to the classification.

12. The method according to claim 8, further comprising:
consulting a recruitment network to identify the direct recruiter of the first market place participant.

13. The method according to claim 8, wherein each marketplace participant is one of a content producer, a recruiter content producer, and a content producer aggregator.

14. The method according to claim 8, further comprising:
determining that the application of the seller does not specify an existing marketplace participant as the direct recruiter;
selecting one of a content producer aggregator and the marketplace itself as the direct recruiter.

15. A system for providing an electronic commerce marketplace, comprising:
a marketplace server connected to a telecommunications network and configured to exchange electronic communications over the network with a plurality of participants and a plurality customers;
a datastore communicatively coupled to the server configured to store listings of goods and services being offered on the marketplace, the marketplace participant associated with each of the goods and services, transaction details of the sale of items from the listing of goods and services, and a recruitment network identifying recruitment associations between the plurality of participants; and
a revenue sharing module configured to:
recognizing revenue generated from the sale of an item supplied to the marketplace by a first marketplace participant; and
apportioning the revenue to at least a second marketplace participant associated with the first marketplace participant.

16. The system according to claim 15, wherein each marketplace participant is one of a content producer, a recruiter content producer, and a content producer aggregator.

17. The system according to claim 15, further comprising:
basing the apportioning on a revenue sharing scheme.

18. The system according to claim 17, further comprising:
determining a classification of the item, and
utilizing the revenue sharing scheme specific to the classification.

19. The system according to claim 15, further comprising:
consulting a recruitment network;
identifying the at least a second marketplace participant as a recruiter of the first marketplace participant based on the recruitment network.

20. The system according to claim 15, further comprising:
identifying a direct recruiter and an indirect recruiter as the at least a second marketplace participant, and wherein the direct recruiter recruited the first marketplace participant to the marketplace, and an indirect recruiter recruited the direct recruiter to the marketplace.
